(19) United States
(12) Patent Application Publication
(10) Pub. No.: US 2008/0258938 A1
(43) Pub. Date: Oct. 23, 2008

(54) System and method for digital vehicle plating

(75) Inventor: James N. Moon, Sterling Heights, MI (US)

Correspondence Address: DOCKET CLERK, DM/EDS, P.O. DRAWER 800889, DALLAS, TX, 75380, US

(73) Assignee: Electronic Data Systems Corporation, Plano, TX (US)

(21) Appl. No.: 11/787,670

(22) Filed: Apr. 17, 2007

(51) Int. Cl. G08G 1/123

(52) U.S. Cl. 340/988; 340/933

(57) ABSTRACT

A method for operating a digital plate on a vehicle. The method includes determining the location of a vehicle and displaying, on a digital plate on the vehicle, registration data corresponding to the vehicle and the vehicle location. The method further includes updating the registration data displayed on the digital plate according to changes in the vehicle location. There is also a corresponding digital plate system and satellite vehicle data system.

### TECHNICAL FIELD

The present disclosure is directed, in general, to automotive identification.

### BACKGROUND OF THE DISCLOSURE

Currently automotive licensing and registration involves the use of physical metal license plates to display the vehicles license plate information. A license plate is typically affixed to both the front and rear of an automobile, includes a series of alphanumeric characters that uniquely identifies that vehicle in the state.

This type of license plate is typically renewed each year through the vehicle registration renewal process of the state Secretary of State. This annual renewal process is time consuming and inconvenient, particularly in those instances where the plate itself must be replaced. The conventional system also causes a cumbersome paper process and burdensome document management for each state.

Physical plates and plastic tags are also susceptible to being lost or stolen.

There is, therefore, a need in the art for an improved system and method for vehicle identification.

### SUMMARY OF THE DISCLOSURE

According to one disclosed embodiment, there is a method for operating a digital plate on a vehicle. The method includes determining the location of a vehicle and displaying, on a digital plate on the vehicle, registration data corresponding to the vehicle and the vehicle location. The method further includes updating the registration data displayed on the digital plate according to changes in the vehicle location.

According to another disclosed embodiment, there is a digital plate system for a vehicle, including a digital plate affixed to a vehicle and a control system connected to control the digital plate. The control system is configured to determine the location of a vehicle; display, on the digital plate, registration data corresponding to the vehicle and the vehicle location; and update the registration data displayed on the digital plate according to changes in the vehicle location.

According to another disclosed embodiment, there is satellite vehicle data system. The satellite vehicle data system includes an antenna configured to receive data from a satellite and a satellite vehicle data system controller connected to the antenna, the satellite vehicle data system controller configured to receive location data, and plate control data. The satellite vehicle data system also includes a digital plate affixed to a vehicle and a control system connected to control the digital plate and connected to the satellite vehicle data system controller. The control system is configured to display, on the digital plate, information corresponding to the location data and the plate control data; and update the information displayed on the digital plate according to changes in the location data.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts some elements of an exemplary digital plate system;

FIG. 2 illustrates communications between elements of an exemplary system;

FIG. 3 depicts a more detailed view of a vehicle 305 with a digital plate system installed; and

FIG. 4 depicts a simplified flowchart of a process in accordance with a disclosed embodiment.

### DETAILED DESCRIPTION

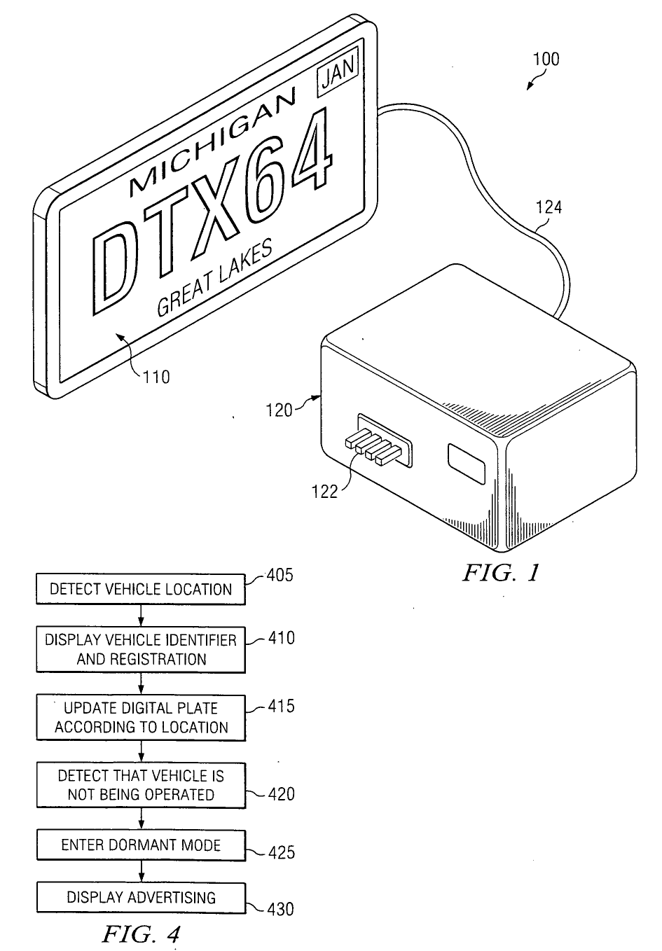

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include a “digital plate” system and method for a dynamic vehicle identification display. FIG. 1 depicts some elements of an exemplary digital plate system. In some embodiments, the identification system 100 includes a 12″×6″ (or other appropriate size) electronic display panel 110, implemented using a liquid crystal display, a light-emitting diode (LED) display, active-matrix transistor-based display, or other known display means. While the display panel described herein is not therefore a “plate” as in a common metal license plate, the term “digital plate” will be used herein to describe the display panel, as will be understood by those of skill in the art, and “digital plate system” will be used to describe not only the display itself, but also other components that interact directly or indirectly with it.

In some embodiments, the digital plate system includes a control system 120 that includes a display cable 124 connected to digital plate 110, and includes data inputs 122. The vehicle's digital plate can display a “Digital Plate signature”, used as a vehicle identifier like a conventional license plate. The digital plate can also include an indication of current vehicle registration. Examples of these are illustrated in FIG. 1, where the digital plate 110 shows the “license plate number” or vehicle identifier, the state of registration, and an indication of current registration or registration expiration. Of course, the particular location and manner in which relevant data is displayed on the digital plate 110 will vary according to the particular implementation and the requirements of the state in which the vehicle is operated.

In some embodiments, the identification system 100 is connected to communicate with, or is implemented as part of, a vehicle's satellite data system 360, such as the OnStar® vehicle data system. This is illustrated in more detail below with regard to FIG. 3.

FIG. 2 illustrates communications between elements of an exemplary system as disclosed herein. Here, a control system 220 and the digital plate 110 are installed in vehicle 205. The system receives data from a satellite 240, which is in communication with a server system 250. Server system 250 has at least a processor and accessible memory and storage, and can be implemented as a data processing system as known to those of skill in the art. Satellite system 240 can be implemented using a satellite system as known to those of skill in the art, such as the OnStar® vehicle data system satellites.

The integration with a satellite communication system allows the digital plate system to dynamically and automatically update or renew the vehicle registration, and correspondingly update the display on the digital plate. In this way, the digital plate can be dynamic updated in place of conventional registration renewal or plate replacement, avoiding the need for the user to make trips to the Secretary of State or county tax office for renewal or replacement of a standard license plate.

FIG. 3 depicts a more detailed view of a vehicle 305 with a digital plate system installed, in communication with or as a part of a satellite vehicle data system. Here, the digital plate 310 is connected to communicate with control system 320. The control system 320 communicates with a satellite vehicle data system controller 360, which is connected to antenna 370 for receiving data from satellites. As before, the satellite vehicle data system 360 can be a system such as the OnStar® vehicle data system or the vehicle data systems produced by Satnav Technologies®.

In some embodiments, the satellite vehicle data system 360 supports global positioning functions, and provides global positioning data to the control system 320. In other embodiments, the control system 320 itself supports global positioning functions, and can determine the geographic location of the vehicle to support other functions. The control system 320 can include a global positioning satellite (GPS) module, a controller, and a memory for storing vehicle data, digital plate data, registration data, location data, advertising data, and other data, to be written to and read from by the controller. If the vehicle is registered in multiple states, then the memory stores a plurality of vehicle registration entries, each registration entry including such data as digital plate data, registration data, and a digital plate signature for each state in which the vehicle is registered.

In some embodiments, the satellite vehicle data system 360 is installed behind the dash of the vehicle or in the passenger compartment. The control system 320 can be installed, in some embodiments, in the trunk space of a vehicle 305. The digital plate 310 can be installed on the rear of the vehicle, in place of a standard license plate or integrated with the vehicle itself. Optionally, a second digital plate 310 can also be installed on the front of the vehicle.

Satellite vehicle data system 360 can receiving data to be displayed on the digital plate, and will communicate this data to control system 320. Control system 320 will then update the display on digital plate 310.

In some embodiments, the digital plate 310 and control system 320 can be integrated with or communicate with a vehicle security system, and can display a theft indicator on the digital plate 310, so that the vehicle 305 can immediately be identified as stolen.

Further, in some embodiments, the digital plate 310 and control system 320 can be configured to display an “expired registration” indicator on the digital plate 310, indicating that the vehicle's registration has expired.

Further, in some embodiments, the digital plate 310 and control system 320 can be configured to display advertising on the digital plate 310, when the digital plate 310 or vehicle are in a “dormant” mode, such as when the vehicle is parked. If the satellite vehicle data system allows for global positioning functions, the advertising can be tailored to the specific location of the vehicle. In this case, the server 250 can send specific advertising to the vehicle for the control system 320 to display on digital plate 310.

Further, in some embodiments, the digital plate 310 and control system 320 can be configured to display other state-sponsored (or state-approved) add-on effects, similar to the “specialty plates” now available in conventional license plates, allowing the driver to customize, to some extent, the digital plate 310 display.

Further, in some embodiments, the digital plate 310 and control system 320 can be configured to maintain vehicle registrations in multiple states. In this case, the digital plate 310 can display one of a plurality of vehicle registrations as set by control system 320. In some embodiments, using global positioning functions, the control system 320 can automatically switches the displayed digital plate signature when the vehicle moves from one state to another, so that the appropriate state registration and vehicle identifier are displayed on digital plate 310.

Another embodiment describes a satellite vehicle data system that includes the antenna, digital plate, and control system described herein. The satellite vehicle data system can receive location data, plate control data, and advertising data from a satellite, and control the digital plate accordingly as described herein. The plate control data can include the registration data, theft information, or other information as described herein. The control system then can display information corresponding to the received data.

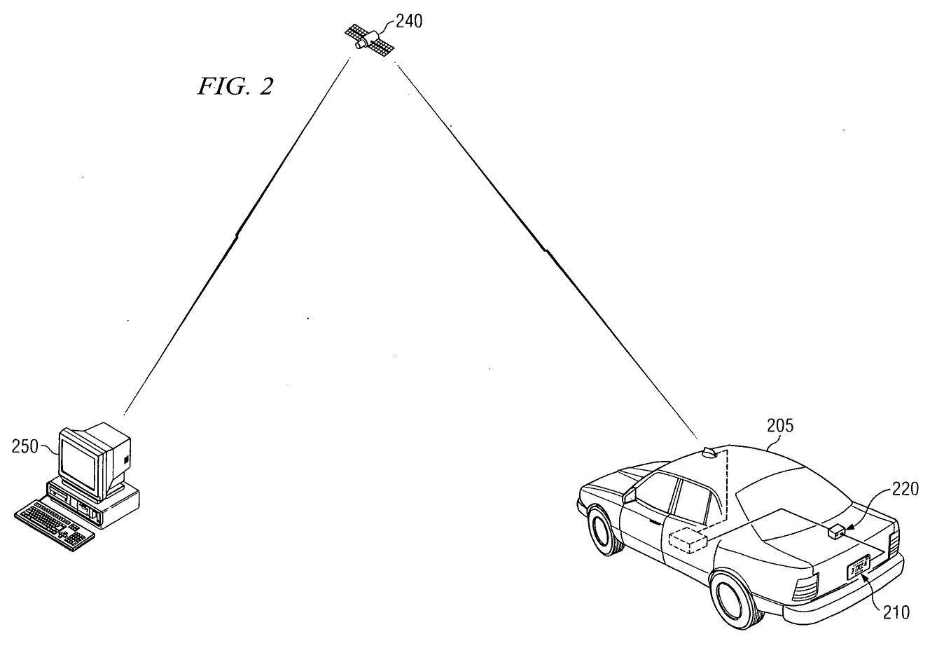

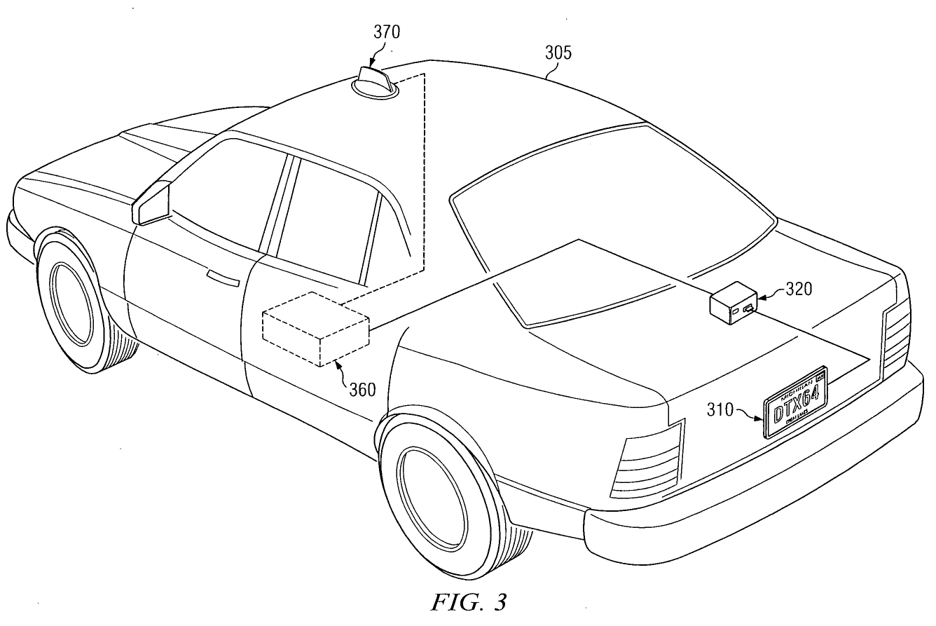

FIG. 4 depicts a simplified flowchart of a process in accordance with a disclosed embodiment.

Here, the digital plate system on a vehicle detects the vehicle location (step 405).

The digital plate system displays the vehicle identifier and vehicle registration data corresponding to the vehicle location on the digital plate (step 410).

The digital plate system updates the digital plate as the appropriate for changes in the vehicle location, including changes in the state in which the vehicle is located (step 415).

At times, the digital plate system can detect that the vehicle is not being operated (step 420). At these times, the digital plate system can enter a dormant mode (step 425).

In the dormant mode, the digital plate system can display advertising on the digital plate (step 430). The advertising can be specific to the location of the vehicle.

Other vehicle systems are described in U.S. Pat. Nos. 5,196,846, 5,621,571, 5,105,179, 5,579,008, and 6,404,327, all of which are hereby incorporated by reference.

Those skilled in the art will recognize that, for simplicity and clarity, the full structure and operation of all systems suitable for use with the present disclosure is not being depicted or described herein. Instead, only so much of a system as is unique to the present disclosure or necessary for an understanding of the present disclosure is depicted and described. The remainder of the construction and operation of the disclosed system may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine usable medium in any of a variety of forms, and that the present disclosure applies equally regardless of the particular type of instruction or signal bearing medium utilized to actually carry out the distribution. Examples of machine usable or machine readable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A method for operating a digital plate on a vehicle, comprising:
determining the location of a vehicle;
displaying, on a digital plate on the vehicle, registration data corresponding to the vehicle and the vehicle location; and
updating the registration data displayed on the digital plate according to changes in the vehicle location.

2. The method of claim 1, wherein the vehicle registration data displayed on the digital plate is updated when the vehicle moves into a different state.

3. The method of claim 1, further comprising displaying advertising on the digital plate according to the location of the vehicle.

4. The method of claim 1, further comprising placing the digital plate in a dormant state.

5. The method of claim 1, further comprising detecting that the vehicle is not being operated.

6. The method of claim 1, further comprising displaying, on the digital plate, an indication that the vehicle has been stolen.

7. The method of claim 1, further comprising displaying, on the digital plate, an indication that the vehicle registration has expired.

8. A digital plate system for a vehicle, comprising:
a digital plate affixed to a vehicle;
a control system connected to control the digital plate, wherein the control system is configured to
determine the location of a vehicle;
display, on the digital plate, registration data corresponding to the vehicle and the vehicle location; and
update the registration data displayed on the digital plate according to changes in the vehicle location.

9. The digital plate system of claim 8, wherein the vehicle registration data displayed on the digital plate is updated when the vehicle moves into a different state.

10. The digital plate system of claim 8, wherein the control system is further configured to display advertising on the digital plate according to the location of the vehicle.

11. The digital plate system of claim 8, wherein the control system is further configured to place the digital plate in a dormant state.

12. The digital plate system of claim 8, wherein the control system is further configured to detect that the vehicle is not being operated.

13. The digital plate system of claim 8, wherein the control system is further configured to display, on the digital plate, an indication that the vehicle has been stolen.

14. The digital plate system of claim 8, wherein the control system is further configured to display, on the digital plate, an indication that the vehicle registration has expired.

15. A satellite vehicle data system, comprising:
an antenna configured to receive data from a satellite;
a satellite vehicle data system controller connected to the antenna, the satellite vehicle data system controller configured to receive location data, and plate control data;
a digital plate affixed to a vehicle;
a control system connected to control the digital plate and connected to the satellite vehicle data system controller, wherein the control system is configured to
display, on the digital plate, information corresponding to the location data and the plate control data; and
update the information displayed on the digital plate according to changes in the location data.

16. The satellite vehicle data system of claim 15, wherein the information displayed on the digital plate is updated when the vehicle moves into a different state.

17. The satellite vehicle data system of claim 15, wherein the satellite vehicle data system controller is further configured to receive advertising data, and the control system is further configured to display information corresponding to the advertising data on the digital plate according to the location of the vehicle.

18. The satellite vehicle data system of claim 15, wherein the control system is further configured to place the digital plate in a dormant state.

19. The satellite vehicle data system of claim 15, wherein the control system is further configured to detect that the vehicle is not being operated.

20. The satellite vehicle data system of claim 15, wherein the control system is further configured to display, on the digital plate, an indication that the vehicle has been stolen.

21. The satellite vehicle data system of claim 15, wherein the control system is further configured to display, on the digital plate, an indication that the vehicle registration has expired.
